(19) United States
(12) Patent Application Publication
(10) Pub. No.: US 2006/0043215 A1
(43) Pub. Date: Mar. 2, 2006

(54) AIR FRESHENER

(76) Inventor: Daniel T. Evans, North Hills, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/162,009

(22) Filed: Aug. 25, 2005

Related U.S. Application Data
(60) Provisional application No. 60/606,797, filed on Sep. 1, 2004.

(51) Int. Cl. B05B 15/00

(52) U.S. Cl. 239/289; 239/34; 239/53; 422/124

(57) ABSTRACT

A ceiling fan/air freshener assembly includes a ceiling fan, a chain extending downwardly from the ceiling fan, and a scented homogenous body attached to the chain.

### BACKGROUND OF THE INVENTION

The present invention generally relates to air fresheners. More particularly, the present invention relates to air fresheners applied to ceiling fans.

Air fresheners are used in a number of ways. Conventional air fresheners are available in liquid sprays, gels, oils, incense, scented polymer and other like materials. These types of sprays work for a short time and only in the area directly sprayed. Sprays can also be dangerous and harmful to some surfaces. Gels, incense, oils, and scented polymer air fresheners used in conjunction with various decorative dispensers can be more aesthetically pleasing than spray bottles, but lack potency and the ability to distribute scent throughout the whole room. Plug-in air fresheners also lack the ability to distribute scent throughout the room. Plug-in air fresheners are also limited to the location of an electrical outlet, which is typically behind a piece of furniture (e.g., a couch, a dresser, a bed) or under a table, rendering it ineffective as a means to spread scent throughout a room.

Accordingly, there is a need for an air freshener designed to be distributed by current household air flow systems. There is a further need for a device which freshens air in a room by utilizing a source of air flow, such as a ceiling fan. There is a need for a device that addresses issues of safety, effectiveness, aesthetics and cost. The present invention fulfills these needs and provides other related advantages.

### SUMMARY OF THE INVENTION

The present invention provides an air freshener designed to be distributed by current household air flow systems. More particularly, the present invention freshens air in a room by utilizing a source of air flow, such as a ceiling fan.

A ceiling fan/air freshener assembly includes a ceiling fan, a chain extending downwardly from the ceiling fan, and a scented homogenous body attached to the chain.

In one embodiment, the scented homogenous body is suspended from the chain.

In another embodiment, the scented homogenous body is co-axially disposed on the chain such that the scented homogenous body forms a portion of the chain. The scented homogenous body may be in the form of a plurality of longitudinally spaced apart scented homogenous bodies.

The scented homogenous body of the assembly includes a central passageway through which the chain extends. A mechanism preventing longitudinal movement of the chain through the passageway is in the form of a wedge.

In another embodiment, the scented homogenous body is connected at an end of the chain.

The scented homogenous body comprises a pendant.

The scented homogenous body is shaped to resemble a sphere, a cube, a pyramid, a star, a polyhedron, or a cylinder.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side elevation view of an air freshener embodying the present invention;

FIG. 2 is a side elevation view of another air freshener embodying the present invention;

FIG. 3 is a bottom plan view of the air fresheners of both FIGS. 1 and 2;

FIG. 4 is a cross-sectional side elevation view of the air freshener of FIG. 1; and

FIG. 5 is a cross-sectional side elevation view of a further air freshener embodying the present invention.

### DETAILED DESCRIPTION OF THE PREFERRED EMBODIMENTS

The present invention is directed to an air freshener configured so as to be used with a source of air flow, such as a ceiling fan.

In accordance with one embodiment of the present invention, an air freshener assembly 10, as illustrated in FIGS. 1, 3 and 4, includes a chain 12 and a scented homogenous body 14 attached to the chain 12. The chain 12 is intended to extend downwardly from a ceiling fan (not shown) with the scented homogenous body 14 suspended from the chain 12. Ceiling fans commonly use a pull chain (not shown) to turn the overhead ceiling fan on and off, or to select the speed of the ceiling fan. The chain 12 includes a means 24 for connecting the chain 12 to the pull-chain of the ceiling fan. This connecting means 24 may be in the form of a flexible clip connector or a ball-chain fastener. Thus, the present invention does not substantially alter the appearance or operation of the conventional overhead ceiling fan.

The chain 12 may come in various forms including, without limitation, a plurality of beads 16 connected by wires 18 (sometimes referred to as a ball-chain), and be made of various material including, without limitation, brass, steel or the like. The scented homogenous body 14 is e comprised of various materials including, without limitation, plastic, ceramic, stone, wood, polymer, paper, gel molds, sachet bags, etc. The scented homogenous body 14 either serves to hold scented material, or is impregnated with scented material. The scented homogenous body 14 may be impregnated with scented material during or after formation.

The scented homogenous body 14 is formed into a variety of shapes including, without limitation, a sphere, a cube, a pyramid, a star, a polyhedron, a cylinder or the like.

In another embodiment, the scented homogenous body 14 is co-axially disposed on the chain 12 such that the scented homogenous body 14 forms a portion of the chain 12. The scented homogenous body 14 may be in the form of a plurality of longitudinally spaced apart scented homogenous bodies 14 of identical or varying shapes. For example, an assembly 10 may include a spherical body 14, a cubed body 14, a pyramidal body 14, a star-shaped body 14, etc. that are all on the same chain 12. The bodies 14 can be fairly artistic in nature so as to enhance the overall aesthetic appearance of the room. For example, the bodies 14 can be in various artistic forms including, without limitation, an angel, a butterfly, a starfish, a pair of playing dice or the like.

A number of bodies 14 of the assembly 10 each include a central passageway 20 extending therethrough for insertion of the chain 12 and through which the chain 12 extends to another an adjacent body 14. At least some, if not all, of the bodies 14 with passageways 20 include a means 22 for preventing longitudinal movement of the chain 12 through the passageways 20 that comprises a wedge secured between two beads 16 of the chain 12, prevents a selected bead 16 of the chain 12 adjacent to the wedge 22 from passing into the passageway 20 in order to keep the scented body 14 from sliding off of the chain 12. The wedge 22 comes in various forms including, without limitation, a piece of bent metal or plastic that has a slot (not shown) that allows the wedge 22 to be placed on the wire 18 between selected adjacent beads 16 of the chain 12. The wedge 22 is disposed within a recess 26 located at a lower end of the body 14.

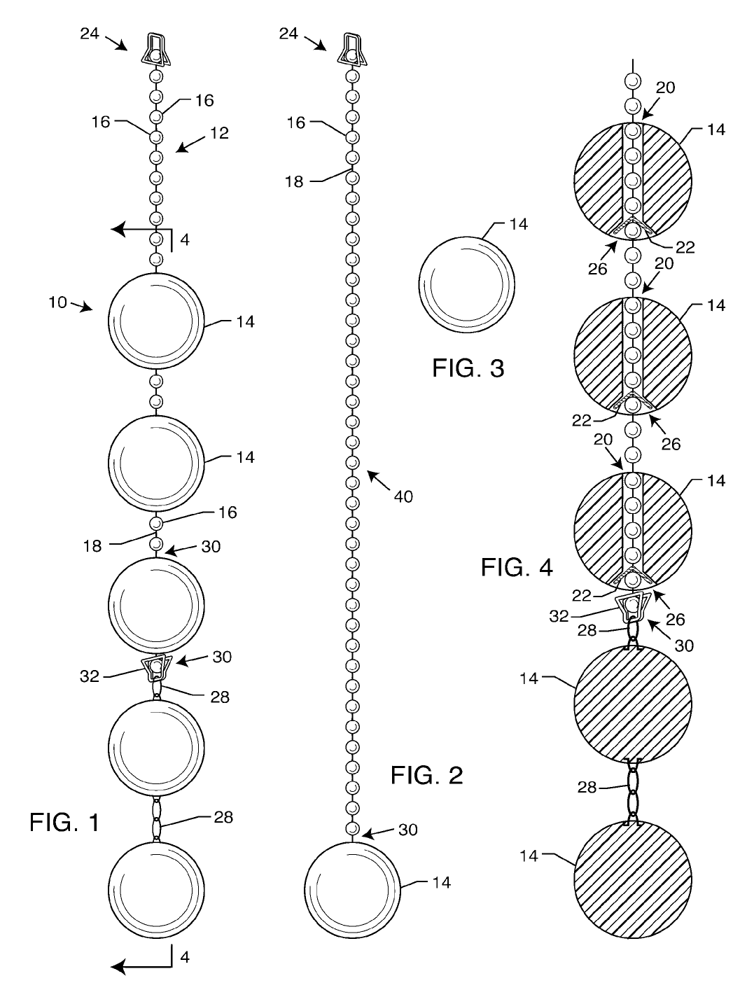

Every body 14 of the chain 12 may be connected to the chain in the fashion described above. In the alternative, one or more bodies 14 at an end of the chain 12 may be connected to each other by links 28 made of various materials including, without limitation, metal or plastic. Ends of the links adjacent to the bodies 14 are embedded in the bodies 14. The scented homogenous bodies 14 connected to the end 30 of the chain 12 serve as pendants hanging from the chain 12. A means 32 for connecting the linked bodies 14 to the chain 12 (FIG. 4), similar to the connecting means 24 described above, is connected to a link 28 extending from one of the linked bodies 14.

In accordance with another embodiment of the present invention, an air freshener assembly 40, as illustrated in FIG. 2 and otherwise similar to assembly 10 described above, includes a chain 12 and a scented homogenous body 14 attached to an end of the chain 12. The scented homogenous body 14 serves as a pendant hanging from the chain 12. The chain 12 includes means 24 for connecting the chain 12 to the pull-chain of the ceiling fan. An end 30 of the chain 12 of this assembly 40 is directly connected to and/or embedded within the body 14.

Alternatively, at the base of the chain 12, a pull-chain ring can be used to actuate the chain 12 without having to physically touch one of the scented bodies 14. In another alternative, the chain 12 may be comprised of scented material (e.g., leather, hemp, plastic, rope or the like) which is saturated with air freshening material. In this manner, the chain 12 itself serves as an air freshener. In yet another alternative, the chain 12 and/or the scented body 14 can be made of or impregnated with a luminous, glow-in-the-dark material.

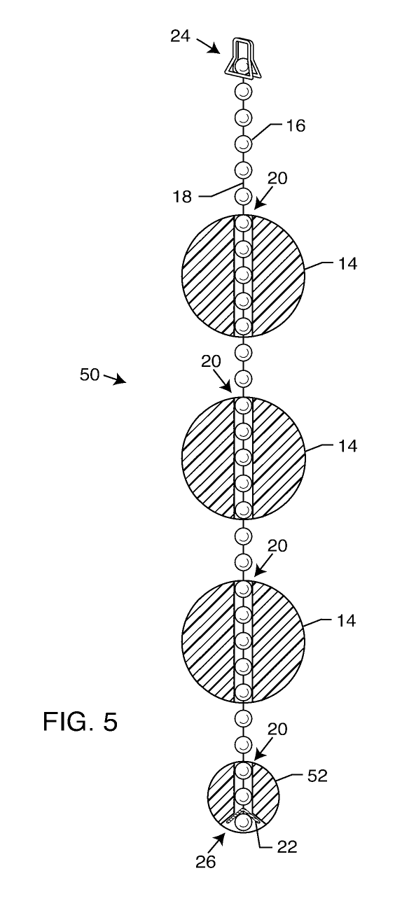

In accordance with a further embodiment of the present invention, an air freshener assembly 50, as illustrated in FIG. 5, and otherwise similar to assemblies 10 and 40 described above, includes a chain 12 and scented homogenous bodies 14 engaging the chain 12. The chain 12 includes means 24 for connecting the chain 12 to the pull chain of the ceiling fan. The scented homogenous bodies 14 are attached to the chain simply by pressure (i.e., the passageway 20 through each homogenous body 14 is slightly smaller in diameter than the beads 16 of the chain 12); providing enough press-fit pressure resistance to statically hold the bodies 14 in place, yet the resistance being light enough to still allow a user to be able to pull the chain 12 through the passageway 20. The assembly 50 includes a pendant 52 at the end of the chain 12. The pendant 52 may be made of a scented or a non-scented material. The passageway of the pendant 52 may be larger than the diameter of the beads 16 of the chain 12. The passageway 20 of the pendant 52 includes means 22 for preventing longitudinal movement of the chain 12 through the passageway 20 that comprises a wedge secured between two beads 16 to the chain. Preventing a selected bead 16 of the chain adjacent to the wedge 22 from passing into the passageway 20 of the pendant 52 in order to keep the pendant 52 from sliding off of the chain 12. The wedge 22 comes in various forms, including, without limitation a piece of bent metal or plastic that has a slot (not shown) that allows the wedge 22 to be placed on the wire 18 between selected adjacent beads 16 of the chain 12. The wedge 22 is disposed within a recess 26 located at a lower end of the pendant 52. The pendant 52 may be smaller than, the same size as, or larger than the scented bodies 14. As shown in FIG. 5, the pendant 52 is smaller in diameter than the scented bodies 14.

It will be appreciated by those skilled in the art that the air freshener assemblies 10, 40, 50 of the present invention are capable of distributing freshened air to a relatively large space due to the air circulation provided by the overhead fan or central air or heating system. The air fresheners of the present invention are either disposed such so as to be unnoticeable or an accent to the overall decor of the room. It will be further appreciated that the air freshener assemblies 10, 40 are capable of being attached to any device that uses a pull-chain including, without limitation, an overhead light fixture, a toilet that uses a pull-chain as part of a flushing mechanism or the like.

Although embodiments of the present invention have been described in detail for purposes of illustration, various modifications may be made without departing from the scope and spirit of the invention.

What is claimed is:

1. A ceiling fan/air freshener assembly, comprising,
a ceiling fan;
a chain extending downwardly from the ceiling fan; and;
a scented homogenous body attached to the chain.

2. The assembly of claim 1, wherein the scented homogenous body is suspended from the chain.

3. The assembly of claim 1, wherein the scented homogenous body is co-axially disposed on the chain.

4. The assembly of claim 3, wherein the scented homogenous body forms a portion of the chain.

5. The assembly of claim 1, wherein the scented homogenous body includes a central passageway through which the chain extends.

6. The assembly of claim 5, including means for preventing longitudinal movement of the chain through the passageway.

7. The assembly of claim 6, wherein the longitudinal movement preventing means comprises a wedge.

8. The assembly of claim 3, wherein the scented homogenous body comprises a plurality of longitudinally spaced apart scented homogenous bodies.

9. The assembly of claim 1, wherein the scented homogenous body is connected at an end of the chain.

10. The assembly of claim 1, wherein the scented homogenous body comprises a pendant.

11. The assembly r of claim 1, wherein the scented homogenous body is shaped to resemble a sphere, a cube, a pyramid, a star, a polyhedron, or a cylinder.

12. A ceiling fan/air freshener assembly, comprising,
a ceiling fan;
a chain extending downwardly from the ceiling fan; and
a plurality of longitudinally spaced apart scented homogenous bodies attached to and co-axially disposed on the chain.

13. The assembly of claim 12, wherein the scented homogenous body is suspended from the chain.

14. The assembly of claim 12, wherein the scented homogenous body forms a portion of the chain.

15. The assembly of claim 12, wherein the scented homogenous body includes a central passageway through which the chain extends.

16. The assembly of claim 15, including a wedge for preventing longitudinal movement of the chain through the passageway.

17. The assembly of claim 12, wherein the scented homogenous body is connected at an end of the chain.

18. The assembly of claim 12, wherein the scented homogenous body comprises a pendant.

19. The assembly r of claim 12, wherein the scented homogenous body is shaped to resemble a sphere, a cube, a pyramid, a star, a polyhedron, or a cylinder.

20. A ceiling fan/air freshener assembly, comprising,
a ceiling fan;
a chain extending downwardly from the ceiling fan;
a plurality of longitudinally spaced apart scented homogenous bodies attached to and co-axially disposed on the chain, each scented homogenous body including a central passageway through which the chain extends and shaped to resemble a sphere, a cube, a pyramid, a star, a polyhedron, or a cylinder, one of the scented homogenous bodies being connected at an end of the chain; and
means for preventing longitudinal movement of the chain through the passageway.
